(19) United States
(12) Patent Application Publication
(10) Pub. No.: US 2018/0181186 A1
(43) Pub. Date: Jun. 28, 2018

(54) BUFFERING DATA FROM HIGH-SPEED I/O TO ENABLE LONGER REDUCED POWER CONSUMPTION STATE RESIDENCY

(71) Applicants: Paul S. DIEFENBAUGH, Portland, OR (US); Kristoffer D. FLEMING, Chandler, AZ (US)

(72) Inventors: Paul S. DIEFENBAUGH, Portland, OR (US); Kristoffer D. FLEMING, Chandler, AZ (US)

(21) Appl. No.: 15/391,195

(22) Filed: Dec. 27, 2016

(51) Int. Cl. G06F 1/32; G06F 3/06

(52) U.S. Cl. CPC G06F 1/3234; G06F 3/067; G06F 3/0659; G06F 3/0625

(57) ABSTRACT

A method and apparatus for buffering data to enable longer reduced power consumption state residency are described. In one embodiment, a computing system comprises a first device operable in one or more reduced power consumption states and a non-reduced power consumption state; one or more I/O devices operable to generate data to be forwarded to the first device; and a write buffer coupled to the first device and the one or more I/O devices to temporarily store data received from one or more I/O devices when the first device is in one of the one or more reduced power consumption states.

### FIELD OF THE INVENTION

Embodiments of the present invention relate to the field of computing systems; more particularly, embodiments of the present invention relate to using a write buffer or memory storage area to buffer data to enable a device that is to receive the data to remain in a reduced power consumption state a period of time until having to leave the reduced power consumption state to receive the data.

### BACKGROUND OF THE INVENTION

As the amount of logic that may be present on integrated circuit devices and the density of integrated circuits has grown, the power requirements for computing systems have also escalated. As a result, there is a vital need for energy efficiency and conservation associated with integrated circuits.

Also, computer system configurations have evolved from a single or multiple integrated circuits in a system to multiple hardware threads, multiple cores, multiple devices, and/or complete systems on individual integrated circuits. For example, a computer system may comprise a processor, which may include a core area and an uncore area. The core area may include one or more processing cores, caches (L1 and L2, for example), line-fill buffers and the uncore area may comprise last level caches, a memory controller, and such other blocks. In one embodiment, the uncore area includes components (e.g., a system agent) that perform functions of the processor that are not in the core. These may include, but are not limited to, memory access functions, input/output (I/O) functions, and/or clocking functions. In one embodiment, these functions are closely connected with the core. The processor power management techniques aim at reducing the power consumed by the core area by changing the power state (e.g., C-states C0, C1, C2, C3, C4, C6) of the cores within the processor based on some criteria such as, for example, activity time or sleep time of the processor.

However, deeper power saving states such as C-state C6 may be associated with a high energy cost for the transitions and such costs may become more significant as residency times of C-states shrink due to high interrupt rates of real-time needs or due to the high interrupt rates caused by input/output (I/O) traffic. Incorrect C-state usage will result in battery life loss instead of gain. Furthermore, incorrect selection of the power saving state may increase the interrupt response time, which may affect performance. The selection of a power saving state (or C-state) is therefore a balance between the energy savings associated with the power state and the performance loss due to the exit latency. Also, entering a deeper sleep state may not be energy conserving (or cost saving) activity if the residency time in that deeper sleep state is not long enough to justify the entry into the deeper sleep state. Such an attempt to enter into the deeper sleep state may be therefore inefficient. Ideally, the longer a processor can state in a deeper sleep state, the longer the Device Idle Duration (DID).

In addition, the static random access memory (SRAM) used by I/O devices to buffer I/O traffic to be sent have increased exponentially and are expected to continue to grow given advancing standards (e.g., 802.11ax, 802.11ad, 802.11ay) employed by I/O devices, faster physical layers (PHYs) associated with such I/O devices, and heavier usage devices (e.g., Wireless Head Mounted Displays (HMDs)). For example, some companies employ wireless fidelity (WiFi) receive (Rx) buffers that are roughly 10-80 KB in size and Wireless Gigabit Alliance (WiGig) 802.11ad Rx buffers that are roughly>100 KB today. These amounts of SRAM will be too small to deliver both meaningful Latency Tolerance (LTR) and at the same time sufficient DID as effective the WiFi bandwidth increases from ˜300 Mbps to 2 Gbps and WiGig bandwidth increases from ˜3 Gbps to over 10 Gbps.

Short LTR and/or DID values prevent a processor from entering into deeper Package C-states and meaningfully increasing system-on-chip (SOC) power (by, for example, 100 mW up to 1200 mW). Preserving LTR/DID behavior would require the SRAM used for the device-local buffers to be tripled in size, resulting in higher die area and cost. Note that (LTR≥100 us) && (DID≥800 us) is required to effectively use Package C6/C7; higher values are needed to enter even deeper states.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of one embodiment of a computer system having a central write buffer (CWB).

FIG. 2 illustrates use of one embodiment of the CWB.

FIG. 3 illustrates an example of peripheral devices that only flush a portion of the data stored in their local buffers.

FIG. 4 is a flow diagram of one embodiment of a hierarchical buffering process.

FIG. 5 illustrates one embodiment of a system level diagram.

### DETAILED DESCRIPTION OF THE PRESENT INVENTION

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

In one embodiment, a computer system includes a write buffer or other memory storage that buffers data from input/output (I/O) or peripheral devices (e.g., endpoints, intellectual property cores/blocks (IPs), network controllers, audio controller, and other I/O devices that have data to process on external events, etc.) to being send to another device (e.g., a processor, central processing unit (CPU), System-on-a-Chip (SoC), etc.) that is in a reduced power consumption state, thereby allowing that device to remain in that state longer than if the device would have to wake up and receive the data from the I/O devices. In one embodiment, the I/O devices generate data and send the data via direct memory access (DMA) writes to memory (e.g., main memory) and the device in the reduced power consumption state is on the path-to-memory such that the device must exit the reduced power consumption state to receive the data and facilitate its forwarding to memory. In one embodiment, the reduced power consumption state is one or more of Package C-states and S-states. In another embodiment, the reduced power consumption state is one or more of the Package C-states. In yet another embodiment, the reduced power consumption state is one or more of the S-states.

In one embodiment, the computer system includes a central write buffer (CWB) in a platform controller hub (PCH) device, or other intermediary or bridge device, that is coupled between a processing device (e.g., a processor, central processing unit (CPU), etc.) and one or more I/O devices on the path-to-memory. In one embodiment of the computer system, the CWB is immediately downstream of a dedicated link referred to as a DMI (Direct Media Interface), an On-package input/output (OPIO) or other internal or external interconnection link that connects a CPU device to the PCH bridge device. In the computer system, I/O or other peripheral devices send data to main memory, and the CPU is on the path-to-memory. By including the CWB on the path-to-memory between the I/O devices and the CPU, the path-to-memory behavior is improved by intercepting and buffering data resulting from I/O activity (e.g., DMA writes) that would otherwise cause the CPU, and thus the system, to break out or otherwise exit deeper and more efficient reduced power consumption states (e.g., Package C-states and S-states).

In one embodiment, the CWB is active only when the CPU is idle (e.g., in a reduced power consumption state) and used to increase the duration and depth of Package C-state residency, in which the CPU package resides as opposed to a Core C-state which only applies to an individual core. The use of the CWB is advantageous in the presence of I/O devices that have little buffering (e.g., legacy devices and controllers) or who's activity is not well-aligned with the CPU's active/idle phases, such as, for example, networking devices (wired and wireless) where traffic received from the network is generally unaligned with CPU active/idle phases.

The techniques described herein improve energy efficiency and battery life by decreasing the frequency of I/O break events and extending the effective Device Idle Duration (DID), yielding longer and deeper Package C-state residency (e.g., C-states C7, C8, C9, etc.) or longer S-state residency, while using minimal centralized SRAM or other buffering. This is needed as I/O devices such as, for example, networking and Universal Serial Bus (USB) devices, continue to increase their effective bandwidth and receive (Rx) data at relatively random times unaligned with CPU and platform power states. The alternative is to add significant local receive (Rx) buffers to each I/O device (e.g., IP) independently, resulting in meaningfully larger total SRAM requirements, die size, and cost.

The use of the CWB in conjunction with improved prefetch buffering improves Package C-state and S-state residency for both natural idle (operating system (OS)-initiated entry into an idle state via MWAIT (an instruction that provides hints to allow the processor to enter an implementation-dependent optimized state)) and Hardware (HW) Duty Cycling (power control unit (PCU)-initiated, aka On/Off Keying) scenarios.

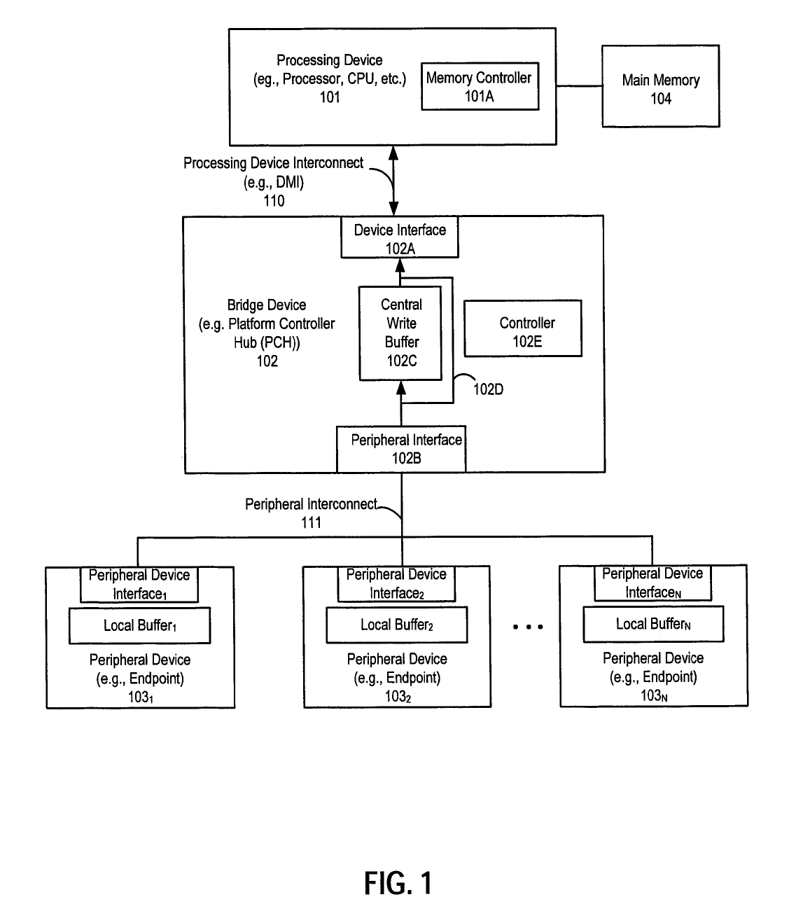

FIG. 1 is a block diagram of one embodiment of a computer system having a CWB. Referring to FIG. 1, a processing device 101 is coupled to memory 104. In one embodiment, processing device 101 is an integrated circuit (IC) device, such as, for example, a processor, CPU, SoC, etc., that is capable of entering and exiting reduced power consumption states (e.g., Package C-states C1-C, Core C-states, P-states, S-states). In one embodiment, processing device 101 includes a memory controller 101A to control accesses by processing device 101 to main memory 104 in a manner well-known in the art.

An intermediary device, such as a bridge device (e.g., PCH), 102 is coupled to processing device 101. In one embodiment, bridge device 102 includes a device interface 102A that is connected to processing device 101 via a processing device interconnect (e.g., DMI, OPIO, Peripheral Component Interface (PCI) Express (PCIe), and other internal or external interconnects). Bridge device 102 also includes a peripheral interface 102B for coupling to peripheral devices, such as peripheral devices_{1-N} (e.g., endpoints) via a peripheral interconnect 111 (e.g., PCIe and other memory transaction based interconnects, etc.).

Bridge device 102 includes a CWB 102C coupled between peripheral interface 102B and device interface 102A. In one embodiment, CWB 102C is enabled when processing device 101 is in a reduced power consumption state in order to buffer data from peripheral devices which would cause the processing device 101 to exit the reduced power consumption state earlier than if processing device 101 had to enter the active state immediately to receive the data and forward the data to main memory 104. Bridge device 102 includes a bypass data path 102D for data to be sent to processing device 101 without buffering in CWB 102C when processing device 101 is in an active state (i.e., a non-reduced power consumption state).

Bridge device 102 also includes a controller 102E to control its operations and perform a number of other functions typically performed by a PCH or bridge device. These functions have not been described in conjunction with FIG. 1 to avoid obscuring the present invention.

Each of peripheral devices_{1-N} comprise a peripheral, or IO, device interface to communicate with bridge device 102 and a local (Rx) buffer to store data that is to be transmitted to memory via the peripheral device interface. For example, peripheral device 1031 comprises interface) and local buffers. In one embodiment, peripheral devices 103_{1-N} comprise IPs (e.g. integrated WiFi, WiGig, an eXtensible Host Controller Interface (xHCI), etc.), audio digital signal processors (DSPs), controllers (e.g., network controllers), accelerators, and other internal or externally connected I/O device. In one embodiment, processing device 101 and the PCH 102 are included in the same device. Such a device may be a System-on-Chip (SoC).

As peripheral devices generate or receive data that is to be sent to main memory 104, the data is stored in their local buffer. From their local buffer, the data is written to main memory 104. In one embodiment, this may be performed using a DMA write operation. In another embodiment, the data may be written in response to an interrupt generated by the peripheral device. In one embodiment, the write operation is performed by the peripheral device when its local buffer has reached a particular level. In one embodiment, the level is an indication that the local buffer is full. In another embodiment, the indication is a watermark level. The watermark level may be set based on the LTR of the data to be sent by the peripheral device. For example, the watermark level may be set to cause a write operation to main memory 104 prior to reaching the LTR.

The data from the peripheral devices are sent to main memory 104 via bridge device 102. If processing device is in a reduced power consumption state (e.g., Package C-state), then the data written from the peripheral devices is temporarily stored in CWB 102C. If processing device is not in a reduced power consumption state (e.g., Package C-state), then the data written from the peripheral devices bypasses CWB 102C using bypass path 102D on its path-to-memory. In one embodiment, bridge device 102 receives a signal or other indication from processing device 101 that indicates that processing device 101 is in a reduced power consumption state. In one embodiment, the signal is referred to as the OBFF signal.

CWB 102C includes a flush watermark. When the amount of data being stored in CWB 102C reaches the flush watermark, CWB 102C flushes the data to processing device 101. In response to the data being sent to processing device 101, processing device 101 wakes up by exiting the reduced power consumption state and causes the data, through the use of memory controller 101A, to be sent to main memory 104. Importantly, however, the use of CWB 102C allows processing device 101 to remain in the reduced power consumption state longer, thereby extending its time in the idle state (e.g., increasing its Device Idle Duration) and reducing overall power consumption.

In one embodiment in which the peripheral devices have large local buffers, it is possible that flushing the entire buffer could swamp the CWB and instigate a wake of processing device 101 without extending the effective Device Idle Duration (DID). For example, in one embodiment, a peripheral device with integrated WiGig includes>100 KB local Rx buffers (required to meet platform LTR requirements) while CWB 102C has only<100 KB of storage space. If the WiGig flushes its entire local buffers at its flush watermark, it would easily saturate CWB 102C and yield no effective benefit from CWB 102C.

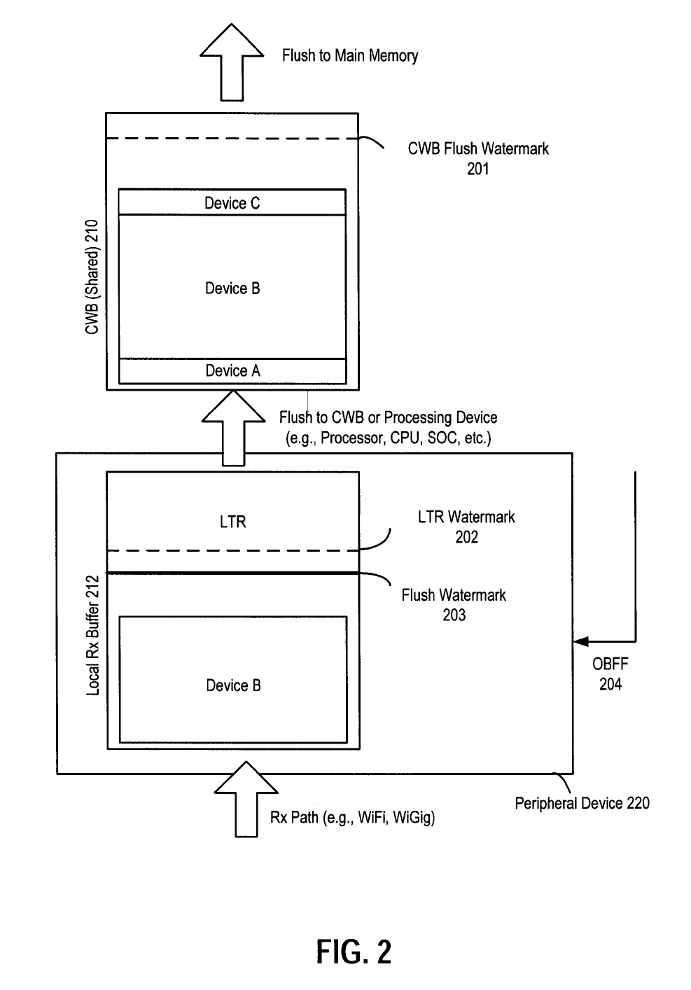

FIG. 2 illustrates the use of one embodiment of the CWB. Referring to FIG. 2, CWB 210 includes a flush watermark 201. When the amount of data being stored temporarily in CWB 210 reaches flush watermark 201, the data is sent to the memory (e.g., main memory 104 of FIG. 1) via a processing device (e.g., processing device 101 of FIG. 1). For example, CWB 210 received and stored data from Device C, Device B, and Device A.

In one embodiment, peripheral devices (e.g., IPs (e.g. integrated Audio, WiFi, WiGig, XHCI, etc.)) include a new flush watermark to fully utilize both CWB 210 and their local buffers. For example, peripheral device includes local buffer 212 that includes a flush watermark 203 along with a LTR watermark 202. In one embodiment, peripheral device 220 performs flush operations (e.g., flushes DMA writes) whenever it's local flush watermark 203 is encountered, but holds off interrupts and other CWB-unfriendly I/O activity until LTR watermark 202 is encountered, the path-to-memory is reopened, a local aging threshold is encountered (e.g., 4 ms maximum hold time for latency-sensitive traffic), or when high priority IO traffic or event occurs, etc. In one embodiment, the indication that the path-to-memory has reopened is signaled by the OBFF signal, indicating that the CPU is in an active state and the path to memory is open and the data in the CWB should be flushed.

In one embodiment, the LTR associated with data from the peripheral devices is managed using local buffers of the respective peripheral device. Specifically, the use of a shared centralized buffer does not facilitate longer LTRs as these buffers are not reserved for specific peripheral devices. The purpose of the CWB is to extend the effective Device Idle Duration (DID) and thus yield longer and deeper Package C-state residency. This paradigm allows DID buffering to be centralized and leveraged across multiple end points and varying usages to reduce, and potentially minimize, the total SRAM and die area impact.

Setting the flush watermark (e.g., flush watermark 203) of the local buffers of peripheral devices close to the LTR watermark (e.g., LTR watermark 202) allows CWB 210 to be effectively utilized when enabled but with negligible penalty when not. In one embodiment, this “negligible penalty” represents the delta between the LTR and flush watermarks, where the flush watermark is programmable and configured as close as possible to the LTR watermark—but not so close that typical delays flushing to CWB 210 would accidentally trigger the LTR watermark.

In one embodiment, peripheral devices activate and/or deactivate their local flush watermark based on the current state of the Opportunistic Buffer Flush/Fill (OBFF) signal. In one embodiment, the OBFF signal indicates whether the path-to-memory is open or closed. For example:
ACTIVE/OBFF→IDLE:EnableFlushWatermark
IDLE→OBFF/ACTIVE:DisableFlushWatermark

The inclusion of CWB and use of a flush watermark (in conjunction with the LTR watermark) with local buffers of peripheral devices allows advanced endpoints (e.g., integrated WiFi, WiGig, XHCI, and the Audio DSP) to effectively use centralized buffering in a scalable manner with minimal coupling and complexity. This reduces the overall die size needed to enable longer and deeper Package C-state residency, resulting lower power (e.g., 100-1200 mW) and longer battery life. This could be extended to centralize nearly all path-to-memory I/O buffering, yielding less total SRAM (smaller die area) but with better net idle behavior (longer effective Device Idle Duration).

In one embodiment, peripheral devices with large local (Rx) buffers could swamp the CWB by flushing the entire buffer contents and causing a wake up of the processing device (e.g., processor, CPU, SoC, etc.) without extending the effective processing device idle time (e.g., DID). To address this, in one embodiment, the peripheral devices include a flush chunk size and when the flush watermark is reached, the peripheral device flushes only a portion of their local Rx buffers equal to the flush chunk size (e.g., 4K chunks, 8K chunks, and other commonly defined chucks size, etc.). In one embodiment, the flush chunk size is programmable.

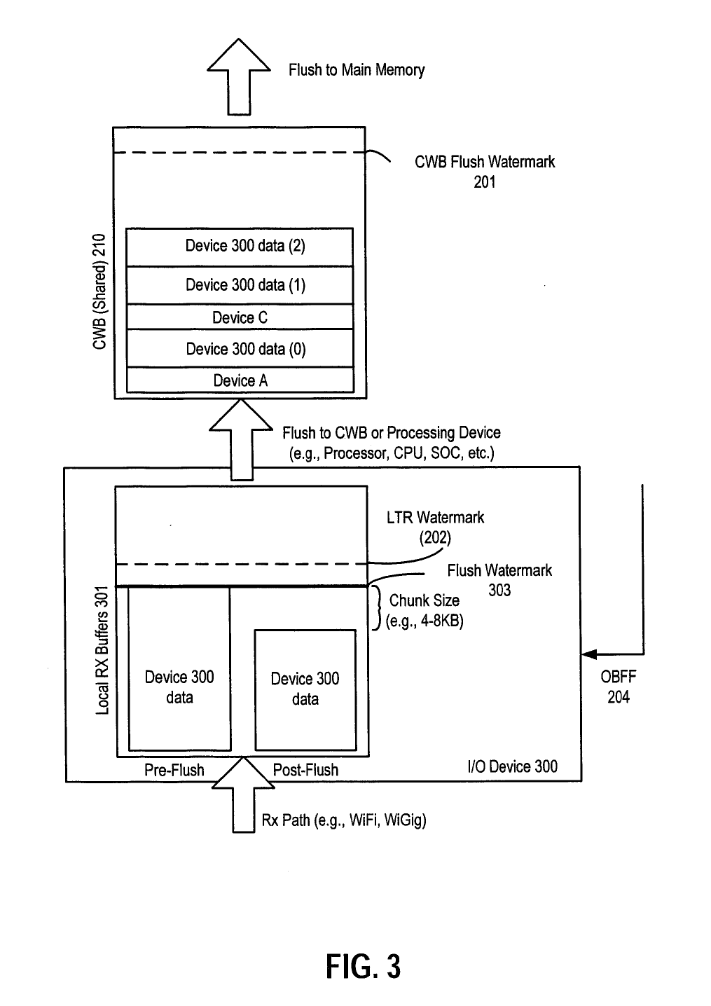

FIG. 3 illustrates an example of peripheral devices that only flush a portion of the data stored in their local buffers. Referring to FIG. 3, when enabled, CWB 210 receives and stores data from one or more peripheral devices. For example, as shown, CWB 210 receives and stores data from Device A, Device C and a IO device 300. While CWB 210 only currently stores only one chunk of data from each of Devices A and C, it contains three different chunks of data from IO device 300.

IO device 300 flushes the data to CWB 210 when the amount of data in local buffer 301 reaches flush watermark 303 (or LTR watermark 202). However, when the amount of data in local buffer 301 reaches flush watermark 303, IO device 300 only flushes a chunk (e.g., 4-8 KB) of the data it is storing in local buffer 301. In the example shown in FIG. 3, the IO device 300 data in local buffer 301 before and after flushing a chunk of data is shown.

Only flushing a chunk of the data stored in a local buffer allows the peripheral devices to fully utilize the CWB when present and enables absorbing these transactions without additional coupling or complexity. In one embodiment, this behavior is only enabled when local buffers of the peripherals are meaningfully large (e.g., greater than ¼th the size of the CWB) and the path-to-memory is closed. In one embodiment, the path-to memory is indicated as closed when the OBFF signal indicates that the CPU is idle.

In one embodiment, peripheral devices having a local flush watermark that is used to trigger flushes of only a portion of the local buffer (e.g., a Flush Chunk Size) can be enabled at different times regardless of whether a CWB is present. In one embodiment, the enablement of such devices is done via the OBFF signal. Such peripheral devices will still function properly even when CWB is not present (e.g., desktop/servers) or when use of the local flush watermark is not enabled (e.g., Package C8 and deeper).

In one embodiment, the addition of a CWB_ACTIVE signal between the CWB and supporting peripheral is used to further optimize local Rx buffering. In this case, peripheral devices would only enable and use their local flush watermark when the CWB_ACTIVE signal is asserted, thereby ensuring that any inefficiency due to the local flush watermark (delta from LTR Watermark) is never encountered by only employing when the CWB is present and able to absorb the chunk-sized flush. That is, the CWB_Active signal provides all peripheral, or IO, devices (e.g., IP blocks) an indication of whether the CWB is buffering and those IO devices should use the local receive buffers based on whether the CWB is active of not. For example, if the CWB is not active, then the device should use all of its local buffer until the high water mark is reached instead of flushing small chunks of data when the CWB is active.

Thus, the techniques described herein provide a simple yet scalable model for utilizing a central buffering resource to significantly extend the effective Device Idle Duration (DID). This is in contrast to existing solutions that avoid centralized buffering or, when a centralized pool of SRAM is present, dedicate portions to specific peripheral devices (non-shared)—resulting in larger net SRAM requirements, larger die area, and higher cost. The hierarchical buffering associated with using a CWB in conjunction with local buffering requires peripheral device-dedicated LTR buffering for data flows (relatively small, e.g., 100 us) but allows all DID buffering (relatively large, e.g., 1 ms+) to be centralized and leveraged across endpoints and usages, with meaningfully less net SRAM, lower leakage, etc.

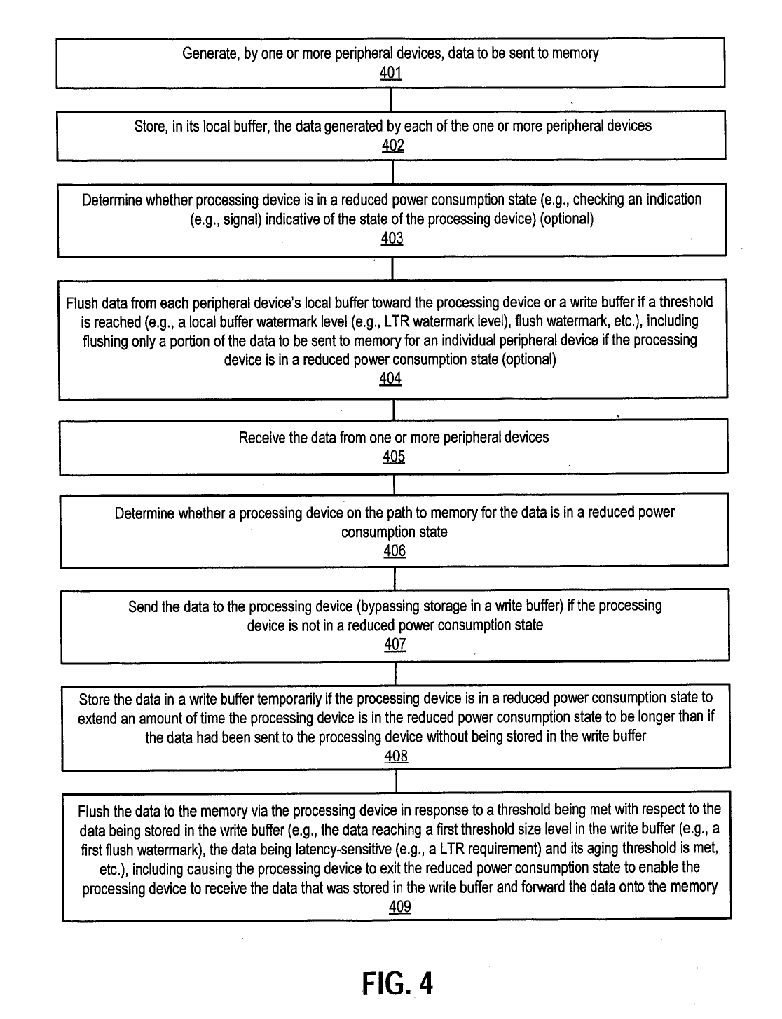

FIG. 4 is a flow diagram of one embodiment of a hierarchical buffering process. In one embodiment, the process is performed by processing logic that may comprise hardware (circuitry, dedicated logic, etc.), software (such as is run on a general purpose computer system or a dedicated machine), firmware, or a combination of the three.

Referring to FIG. 4, the process begins by generating, by one or more peripheral devices, data to be sent to memory (processing block 401) and storing, in its local buffer, the data generated by each of the one or more peripheral devices (processing block 402).

Next, processing logic in the one or more peripheral devices determines whether the processing device is in a reduced power consumption state (processing block 403). In one embodiment, this is performed by checking an indication (e.g., OBFF signal) indicative of the state of the processing device. This is an optional step and is used when the peripheral device is configured to only flush a chuck of data when its local watermark level (not the LTR watermark level) has been reached.

Processing logic flushes data from each peripheral device's local buffer toward the processing device or a write buffer if a threshold is reached (processing block 404). In one embodiment, the threshold is a local buffer watermark level. In another embodiment, the threshold is a LTR watermark level. In one embodiment, the processing logic only flushes a portion of the data to be sent to memory (via the processing device) for an individual peripheral device if the processing device is in a reduced power consumption state. This is also an optional step and is used when the peripheral device is configured to only flush a chuck of data when its local watermark level (not the LTR watermark level) has been reached.

Under control of processing logic, the intermediary (e.g., bridge) device receives the data from one or more peripheral devices (processing block 405) and determines whether a processing device on the path to memory for the data is in a reduced power consumption state (processing block 406). Based on the results of the determination, processing logic either sends the data to the processing device (bypassing storage in a write buffer) (if the processing device is not in a reduced power consumption state) (processing block 407) or stores the data in a write buffer temporarily (if the processing device is in a reduced power consumption state) to extend an amount of time the processing device is in the reduced power consumption state to be longer than if the data had been sent to the processing device without being stored in the write buffer (processing block 408).

Subsequently, if the data is stored in the CWB, processing logic flushes the data to the memory (e.g., main memory) via the processing device in response to a threshold being met with respect to the data being stored in the write buffer (processing block 409). In one embodiment, the threshold corresponds to the data reaching a first threshold size level in the write buffer (e.g., a first flush watermark). In another embodiment, data is flushed where the data being latency-sensitive (e.g., a LTR requirement) and its aging threshold is met. This causes the processing device to exit the reduced power consumption state to enable the processing device to receive the data that was stored in the write buffer and forward the data onto the memory.

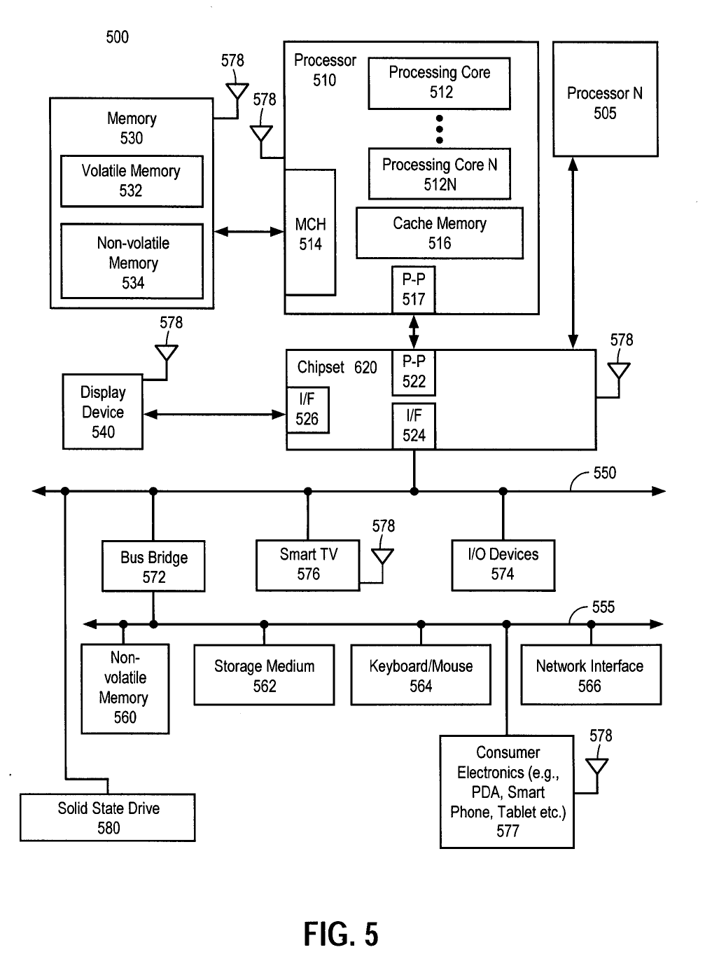

FIG. 5 is one embodiment of a system level diagram 500 that may incorporate the techniques described above. For example, the techniques described above may be incorporated into an interconnect or interface in system 500.

Referring to FIG. 5, system 500 includes, but is not limited to, a desktop computer, a laptop computer, a netbook, a tablet, a notebook computer, a personal digital assistant (PDA), a server, a workstation, a cellular telephone, a mobile computing device, a smart phone, an Internet appliance or any other type of computing device. In another embodiment, system 500 implements the methods disclosed herein and may be a system on a chip (SOC) system.

In one embodiment, processor 510 (e.g., processing device 101 of FIG. 1) has one or more processor cores 512 to 512N, where 512N represents the Nth processor core inside the processor 510 where N is a positive integer. In one embodiment, system 500 includes multiple processors including processors 510 and 505, where processor 505 has logic similar or identical to logic of processor 510. In one embodiment, system 500 includes multiple processors including processors 510 and 505 such that processor 505 has logic that is completely independent from the logic of processor 510. In such an embodiment, a multi-package system 500 is a heterogeneous multi-package system because the processors 505 and 510 have different logic units. In one embodiment, processing core 512 includes, but is not limited to, pre-fetch logic to fetch instructions, decode logic to decode the instructions, execution logic to execute instructions and the like. In one embodiment, processor 510 has a cache memory 516 to cache instructions and/or data of the system 500. In another embodiment of the invention, cache memory 516 includes level one, level two and level three, cache memory, or any other configuration of the cache memory within processor 510.

In one embodiment, processor 510 includes a memory control hub (MCH) 514, which is operable to perform functions that enable processor 510 to access and communicate with a memory 530 that includes a volatile memory 532 and/or a non-volatile memory 534. In one embodiment, memory control hub (MCH) 514 is positioned outside of processor 510 as an independent integrated circuit.

In one embodiment, processor 510 is operable to communicate with memory 530 and a chipset 520 (e.g., PCH or bridge device 102). In such an embodiment, SSD 580 executes the computer-executable instructions when SSD 580 is powered up.

In one embodiment, processor 510 is also coupled to a wireless antenna 578 to communicate with any device configured to transmit and/or receive wireless signals. In one embodiment, wireless antenna interface 578 operates in accordance with, but is not limited to, the IEEE 802.11 standard and its related family, HomePlug AV (HPAV), Ultra Wide Band (UWB), Bluetooth, WiMAX, 3G, 4G, 5G or any form of wireless communication protocol.

In one embodiment, the volatile memory 532 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. Non-volatile memory 534 includes, but is not limited to, flash memory (e.g., NAND, NOR), phase change memory (PCM), read-only memory (ROM), electrically erasable programmable read-only memory (EEPROM), or any other type of non-volatile memory device.

Memory 530 stores information and instructions to be executed by processor 510. In one embodiment, chip set 520 connects with processor 510 via Point-to-Point (PtP or P-P) interfaces 517 and 522. In one embodiment, chipset 520 enables processor 510 to connect to other modules in the system 500. In one embodiment, interfaces 517 and 522 operate in accordance with a PtP communication protocol such as the Intel QuickPath Interconnect (QPI) or the like. In one embodiment, the interconnection is between processor 500 and a peripheral hub controller. In another embodiment, the interconnection is between an internal buses and/or fabrics to interconnect and provide a path to memory.

In one embodiment, chip set 520 is operable to communicate with processor 510, 505, display device 540, and other devices 572, 576, 574, 560, 562, 564, 566, 577, etc. In one embodiment, chipset 520 is also coupled to a wireless antenna 578 to communicate with any device configured to transmit and/or receive wireless signals.

In one embodiment, chipset 520 connects to a display device 540 via an interface 526. In one embodiment, display device 540 includes, but is not limited to, liquid crystal display (LCD), plasma, cathode ray tube (CRT) display, or any other form of visual display device. In addition, chipset 520 connects to one or more buses 550 and 555 that interconnect various modules 574, 560, 562, 564, and 566. In one embodiment, buses 550 and 555 may be interconnected together via a bus bridge 572 if there is a mismatch in bus speed or communication protocol. In one embodiment, chipset 520 couples with, but is not limited to, a non-volatile memory 560, a mass storage device(s) 562, a keyboard/mouse 564, and a network interface 566 via interface 524, smart TV 576, consumer electronics 577, etc.

In one embodiment, mass storage device 562 includes, but is not limited to, a solid state drive, a hard disk drive, a universal serial bus flash memory drive, or any other form of computer data storage medium. In one embodiment, network interface 566 is implemented by any type of well-known network interface standard including, but not limited to, an Ethernet interface, a universal serial bus (USB) interface, a Peripheral Component Interconnect (PCI) Express interface, a wireless interface and/or any other suitable type of interface.

While the modules shown in FIG. 5 are depicted as separate blocks within the system 500, the functions performed by some of these blocks may be integrated within a single semiconductor circuit or may be implemented using two or more separate integrated circuits.

There are a number of example embodiments described herein.

Example 1 is a computing system comprising a first device operable in one or more reduced power consumption states and a non-reduced power consumption state; one or more I/O devices operable to generate data to be forwarded to the first device; and a write buffer coupled to the first device and the one or more I/O devices to temporarily store data received from one or more I/O devices when the first device is in one of the one or more reduced power consumption states.

Example 2 is the computing system of example 1 that may optionally include that the data being buffered by the write buffer is destined for a memory and the first device is on a path to the memory, the write buffer enabling the first device to remain in the one reduced power consumption state longer than if the data had been sent to the first device without being stored in the write buffer to extend idle duration of the first device.

Example 3 is the computing system of example 2 that may optionally include that the data in the write buffer is flushed to the memory via the first device in response to a first amount of data being stored in the write buffer reaching a first level, the first amount being a first flush watermark.

Example 4 is the computing system of example 3 that may optionally include that the first amount is based on a latency tolerance reporting (LTR) associated with data from the one or more I/O devices.

Example 5 is the computing system of example 2 that may optionally include that the data in the write buffer is flushed to the memory via the first device in response to data stored in the write buffer being latency-sensitive and an ageing threshold being met with respect the data stored in the write buffer.

Example 6 is the computing system of example 2 that may optionally include that the write buffer is shared among a plurality of I/O devices by storing data from more than two I/O devices at one time.

Example 7 is the computing system of example 6 that may optionally include that the each of the one or more I/O devices include a local buffer for data that is being sent to the memory and flushes the data, wherein data flushed from local buffers of the I/O devices to the memory are stored in the write buffer when the first device is in one of the reduced power consumption states and bypasses the write buffer when the first device is in the non-reduced power consumption state.

Example 8 is the computing system of example 7 that may optionally include that each of the I/O devices flushes only a portion of the data in its local buffer in response to a second amount of data being stored in the local buffer reaching a second level, the portion being less than the second amount of data.

Example 9 is the computing system of example 8 that may optionally include that the second amount for each IP is based on a latency tolerance reporting (LTR) associated with data from said each IP.

Example 10 is a device for use in a computing system, where the device comprises a first interface for coupling to an first device; a set of one or more second interfaces to receive data from one or more I/O devices, the data being destined for the first device; and a write buffer coupled to the first interface and the set of one or more second interfaces to temporarily store data received from the one or more I/O devices when the first device is in one of the one or more reduced power consumption states.

Example 11 is the device of example 10 that may optionally include that the data being buffered by the write buffer is destined for a memory and the first device is on a path to the memory, the write buffer enabling the first device to remain in the one reduced power consumption state longer than if the data had been sent to the first device without being stored in the write buffer.

Example 12 is the device of example 11 that may optionally include that the write buffer is operable to flush the data to the memory via the first device in response to a first amount of data being stored in the write buffer reaching a first level, the first amount being a first flush watermark.

Example 13 is the device of example 12 that may optionally include that the first amount is based on a latency tolerance reporting (LTR) associated with data from the one or more I/O devices.

Example 14 is the device of example 11 that may optionally include that the write buffer is operable to flush the data to the memory via the first device in response to data stored in the write buffer being latency-sensitive and an ageing threshold being met with respect the data stored in the write buffer.

Example 15 is the device of example 11 that may optionally include that the write buffer is operable to share its storage space with data from a plurality of I/O devices by storing data from more than two I/O devices at one time.

Example 16 is a machine-readable medium having stored thereon one or more instructions, which if performed by a machine causes the machine to perform a method comprising: receiving data from one or more I/O devices, the data to be transferred to a first device; determining whether the first device is in a reduced power consumption state; storing the data in a write buffer temporarily if the first device is in a reduced power consumption state to extend an amount of time the first device is in the reduced power consumption state to be longer than if the data had been sent to the first device without being stored in the write buffer; and flushing the data to the memory via the first device in response to a first amount of data being stored in the write buffer reaching a first level, the first amount being a first flush watermark, including causing the first device to exit the reduced power consumption state to enable the first device to receive the data that was stored in the write buffer.

Example 17 is the machine-readable medium of example 16 that may optionally include that the data being buffered by the write buffer is destined for transfer to a memory and the first device is on a path to the memory.

Example 18 is the machine-readable medium of example 16 that may optionally include that the first amount is based on a latency tolerance reporting (LTR) associated with data from the one or more I/O devices.

Example 19 is the machine-readable medium of example 16 that may optionally include that the method further comprises flushing the data to the memory via the first device in response to data stored in the write buffer being latency-sensitive and an ageing threshold being met with respect the data stored in the write buffer.

Example 20 is the machine-readable medium of example 16 that may optionally include that storing the data in a write buffer comprises sharing storage in the write buffer with data from a plurality of I/O devices at one time.

Example 21 is the machine-readable medium of example 16 that may optionally include that the each of the one or more I/O devices include a local buffer for data that is being sent to the memory and flushes the data, wherein data flushed from local buffers of the I/O devices to the memory are stored in the write buffer when the first device is in one of the reduced power consumption states and bypasses the write buffer when the first device is in the non-reduced power consumption state.

Example 22 is the machine-readable medium of example 21 that may optionally include that the method further comprises each of the I/O devices flushing only a portion of the data in its local buffer in response to a second amount of data being stored in the local buffer reaching a second level, the portion being less than the second amount of data.

Example 23 is the machine-readable medium of example 22 that may optionally include that the second amount for each IP is based on a latency tolerance reporting (LTR) associated with data from said each IP.

Example 24 is a processor or other apparatus operative to perform the method of any one of examples 16 to 23.

Example 25 is a processor or other apparatus that includes means for performing the method of any one of examples 16 to 23.

Example 26 is a processor or other apparatus substantially as described herein.

Example 27 is a processor or other apparatus that is operative to perform any method substantially as described herein.

Example 28 is a processor or other apparatus that is operative to perform any instructions/operations substantially as described herein.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A computing system comprising:
a first device operable in one or more reduced power consumption states and a non-reduced power consumption state;
one or more I/O devices operable to generate data to be forwarded to the first device; and
a write buffer coupled to the first device and the one or more I/O devices to temporarily store data received from one or more I/O devices when the first device is in one of the one or more reduced power consumption states.

2. The computing system defined in claim 1 wherein the data being buffered by the write buffer is destined for a memory and the first device is on a path to the memory, the write buffer enabling the first device to remain in the one reduced power consumption state longer than if the data had been sent to the first device without being stored in the write buffer to extend idle duration of the first device.

3. The computing system defined in claim 2 wherein the data in the write buffer is flushed to the memory via the first device in response to a first amount of data being stored in the write buffer reaching a first level, the first amount being a first flush watermark.

4. The computing system defined in claim 3 wherein the first amount is based on a latency tolerance reporting (LTR) associated with data from the one or more I/O devices.

5. The computing system defined in claim 2 wherein the data in the write buffer is flushed to the memory via the first device in response to data stored in the write buffer being latency-sensitive and an ageing threshold being met with respect the data stored in the write buffer.

6. The computing system defined in claim 2 wherein the write buffer is shared among a plurality of I/O devices by storing data from more than two I/O devices at one time.

7. The computing system defined in claim 6 wherein the each of the one or more I/O devices include a local buffer for data that is being sent to the memory and flushes the data, wherein data flushed from local buffers of the I/O devices to the memory are stored in the write buffer when the first device is in one of the reduced power consumption states and bypasses the write buffer when the first device is in the non-reduced power consumption state.

8. The computing system defined in claim 7 wherein each of the I/O devices flushes only a portion of the data in its local buffer in response to a second amount of data being stored in the local buffer reaching a second level, the portion being less than the second amount of data.

9. The computing system defined in claim 8 wherein the second amount for each IP is based on a latency tolerance reporting (LTR) associated with data from said each IP.

10. A device for use in a computing system, the device comprising:
a first interface for coupling to an first device;
a set of one or more second interfaces to receive data from one or more I/O devices, the data being destined for the first device; and
a write buffer coupled to the first interface and the set of one or more second interfaces to temporarily store data received from the one or more I/O devices when the first device is in one of the one or more reduced power consumption states.

11. The device defined in claim 10 wherein the data being buffered by the write buffer is destined for a memory and the first device is on a path to the memory, the write buffer enabling the first device to remain in the one reduced power consumption state longer than if the data had been sent to the first device without being stored in the write buffer.

12. The device defined in claim 11 wherein the write buffer is operable to flush the data to the memory via the first device in response to a first amount of data being stored in the write buffer reaching a first level, the first amount being a first flush watermark.

13. The device defined in claim 12 wherein the first amount is based on a latency tolerance reporting (LTR) associated with data from the one or more I/O devices.

14. The device defined in claim 11 wherein the write buffer is operable to flush the data to the memory via the first device in response to data stored in the write buffer being latency-sensitive and an ageing threshold being met with respect the data stored in the write buffer.

15. The device defined in claim 11 wherein the write buffer is operable to share its storage space with data from a plurality of I/O devices by storing data from more than two I/O devices at one time.

16. A machine-readable medium having stored thereon one or more instructions, which if performed by a machine causes the machine to perform a method comprising:
receiving data from one or more I/O devices, the data to be transferred to a first device;
determining whether the first device is in a reduced power consumption state;
storing the data in a write buffer temporarily if the first device is in a reduced power consumption state to extend an amount of time the first device is in the reduced power consumption state to be longer than if the data had been sent to the first device without being stored in the write buffer; and
flushing the data to the memory via the first device in response to a first amount of data being stored in the write buffer reaching a first level, the first amount being a first flush watermark, including causing the first device to exit the reduced power consumption state to enable the first device to receive the data that was stored in the write buffer.

17. The machine-readable medium defined in claim 16 wherein the data being buffered by the write buffer is destined for transfer to a memory and the first device is on a path to the memory.

18. The machine-readable medium defined in claim 16 wherein the first amount is based on a latency tolerance reporting (LTR) associated with data from the one or more I/O devices.

19. The machine-readable medium defined in claim 16 wherein the method further comprises flushing the data to the memory via the first device in response to data stored in the write buffer being latency-sensitive and an ageing threshold being met with respect the data stored in the write buffer.

20. The machine-readable medium defined in claim 16 wherein storing the data in a write buffer comprises sharing storage in the write buffer with data from a plurality of I/O devices at one time.

21. The machine-readable medium defined in claim 16 wherein each of the one or more I/O devices include a local buffer for data that is being sent to the memory and flushes the data, wherein data flushed from local buffers of the I/O devices to the memory are stored in the write buffer when the first device is in one of the reduced power consumption states and bypasses the write buffer when the first device is in the non-reduced power consumption state.

22. The machine-readable medium defined in claim 21 wherein the method further comprises each of the I/O devices flushing only a portion of the data in its local buffer in response to a second amount of data being stored in the local buffer reaching a second level, the portion being less than the second amount of data.

23. The machine-readable medium defined in claim 22 wherein the second amount for each IP is based on a latency tolerance reporting (LTR) associated with data from said each IP.
